(19) United States
(12) Patent Application Publication
(10) Pub. No.: US 2024/0367878 A1
(43) Pub. Date: Nov. 7, 2024

(54) RECYCLABLE PACKAGING FILM

(71) Applicant: AMCOR FLEXIBLES NORTH AMERICA, INC., Neenah, WI (US)

(72) Inventors: Ankush A. GOKHALE, Fulshear, TX (US); Kevin P. NELSON, Appleton, WI (US)

(21) Appl. No.: 18/572,623

(22) PCT Filed: Jun. 28, 2021
(86) PCT No.: PCT/US2021/039352

§ 371 Date: Dec. 20, 2023

(51) Int. Cl. B65D 65/40; B29C 35/08; B29K 23/00; B29L 7/00; B32B 7/12; B32B 27/08; B32B 27/16; B32B 27/30; B32B 27/32

(52) U.S. Cl. CPC B65D 65/40; B29C 35/0866; B32B 7/12; B32B 27/08; B32B 27/16; B32B 27/306; B32B 27/32; B29C 2035/0872; B29K 2023/086; B29K 2023/12; B29K 2995/0053; B29K 2995/0067; B29L 2007/008; B32B 2250/24; B32B 2307/514; B32B 2307/7244; B32B 2439/70; B65D 2565/385

(57) ABSTRACT

A recyclable packaging film includes an irradiated first film and a second film laminated to the first film. The first film includes a first polypropylene layer, a second polypropylene layer, and an ethylene vinyl alcohol (EVOH) layer between the first and second polypropylene layers.

### FIELD

The present application relates generally to recyclable packaging films having an irradiated ethylene vinyl alcohol (EVOH) layer to provide barrier properties.

### TECHNICAL BACKGROUND

Qualification of a film as recyclable is currently not regulated by any specific agencies. However, some common criteria tend to be shared among various groups, such as Association of Plastic Recyclers (APR), Circular Economy for Flexible Packaging (CEFLEX), and How2Recycle™, which have set industry qualifications for recyclability.

For example, plastic materials that are formed from a single type of polymer, or that have a single type of polymer that forms a substantial portion of the material, tend to be recyclable. Plastic materials formed from many different polymers with no particular polymer forming a substantial portion of the material tend not to be recyclable.

As another example, plastic materials that are not substantially crosslinked tend to be recyclable, while plastic materials that are highly crosslinked tend not to be recyclable. Cross linking of a thermoplastic polymer may prevent the polymer from readily flowing, and thus may prevent the polymer from being reused. Accordingly, highly crosslinked thermoplastics may not be recyclable.

Many recyclable plastic films are formed from polyethylene. However, polyethylene films tend to have poor oxygen barrier properties and, thus, may be less appropriate for some uses.

Poly (ethylene vinyl alcohol) (EVOH) films have oxygen barrier properties, which may improve when irradiated with ionizing radiation. Accordingly, incorporating irradiated EVOH layers into films may improve oxygen barrier properties of the films.

However, incorporating irradiated EVOH layers into films may not be practical, and incorporating EVOH layers into films and then irradiating the films to improve the oxygen barrier properties of the film may result in substantial cross-linking, which may render the film unsuitable for recycling. For example, polyethylene is known to substantially cross link when exposed to ionizing radiation.

### BRIEF SUMMARY

This disclosure, among other things, relates to recyclable packaging films having an irradiated ethylene vinyl alcohol (EVOH) layer to provide barrier properties. Despite exposure to ionizing radiation, the films remain recyclable.

Surprisingly, the inventors found that the ability of ionizing radiation to improve barrier properties of multilayer films having an EVOH layer varied depending on the composition of other layers of the multilayer film. Some adjacent layers substantially prevented the ionizing radiation from enhancing the barrier properties of the EVOH layer, while other adjacent layers enhanced the ability of ionizing radiation to improve the barrier properties of the film. For example, the length of time that the multilayer film exhibited enhanced barrier properties following exposure to ionizing radiation was increased when the EVOH layer was between layers of certain compositions.

Polypropylene was determined to be particularly effective at enhancing the improved barrier property effect of ionizing radiation on the EVOH layer.

In some aspects described herein, a recyclable packaging film comprises an irradiated first film and a second film laminated to the first film. The first film comprises a first polypropylene layer, a second polypropylene layer, and an ethylene vinyl alcohol (EVOH) layer between the first and second polypropylene layers. Polypropylene is a scission prone polymer and does not substantially crosslink when exposed to ionizing radiation, and thus maintains recyclability.

The second film may comprise an oriented polypropylene layer. Printing material may be applied to the oriented polypropylene layer. The recyclable packaging film may comprise a third film. The third film may comprise a seal layer. The seal layer may comprise a polyolefin, such as polypropylene or polyethylene.

The second film may comprise a seal layer. The seal layer may comprise a polyolefin, such as polypropylene or polyethylene. The first film may be oriented. Printing material may be applied to the oriented first film.

The recyclable packaging film preferably comprises 80% or more polyolefin by weight. such as 90% or more polyolefin by weight or 95% or more polyolefin by weight. Preferably, the recyclable packaging film comprises 80% or more polypropylene by weight, such as 90% or more polypropylene by weight or 95% or more polypropylene by weight. Preferably, the recyclable packaging film comprises 20% or less EVOH by weight, such as 10% or less EVOH by weight or 5% or less EVOH by weight.

In some embodiments, the recyclable packaging film is used in packaging a food product. Accordingly, a method may include sealing a food product in the recyclable packaging film to form a packaged food product. Thus, in some embodiments, a packaged food product may include a food product packaged in the recyclable packaging film. The food product may have a water activity of 0.65 or greater, such as 0.8 or greater, or in a range from 0.8 to 1.

In some aspects described herein, a method for manufacturing a recyclable packaging film includes (i) forming a first film comprising a first polypropylene layer, a second polypropylene layer, and an ethylene vinyl alcohol (EVOH) layer between the first and second polypropylene layers: (ii) exposing the first film to ionizing radiation to form an irradiated first film; and (iii) laminating the first film to a second film.

The second film employed in the method may comprise an oriented polypropylene layer. Printing material may be applied to the oriented polypropylene layer. The method may further comprise laminating a third film to the first film. The third film may comprise a seal layer. The seal layer may comprise a polyolefin, such as polypropylene or polyethylene.

The second film employed in the method may comprise a seal layer. The seal layer may comprise a polyolefin, such as polypropylene or polyethylene. The first film may be oriented. Printing material may be applied to the oriented first film.

The recyclable packaging film produced by the method preferably comprises 80% or more polyolefin by weight, such as 90% or more polyolefin by weight or 95% or more polyolefin by weight. Preferably, the recyclable packaging film comprises 80% or more polypropylene by weight, such as 90% or more polypropylene by weight or 95% or more polypropylene by weight. Preferably, the recyclable packaging film comprises 20% or less EVOH by weight, such as 10% or less EVOH by weight or 5% or less EVOH by weight.

It is to be understood that both the foregoing general description and the following detailed description present embodiments of the subject matter of the present disclosure and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings. where like structure is indicated with like reference numerals and in which:

FIG. 1 is a schematic drawing of a cross-section of a recyclable packaging film in accordance with an embodiment described herein;

FIG. 2 is a schematic view of an embodiment of a packaged product; and

FIG. 3 is a flow diagram of an embodiment of a method for manufacturing a recyclable packaging film.

The schematic drawings are not necessarily to scale. Like numbers used in the figures refer to like components. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### DETAILED DESCRIPTION

Reference will now be made in greater detail to various embodiments of the subject matter of the present disclosure, some embodiments of which are illustrated in the accompanying drawings.

This disclosure, among other things, relates to recyclable packaging films having an irradiated EVOH layer to provide barrier properties. The recyclable packaging films preferably comprise an irradiated first film having a first layer of polypropylene, a second layer polypropylene, and an EVOH layer between the first and second layers of polypropylene. In some embodiments, the irradiated first film comprises only one EVOH layer.

The recyclable packaging films described herein may be recycled after their primary use is completed. As used herein, the term “recyclable” is meant to indicate that the film can be converted into a new useful item, by means of reprocessing. Reprocessing may entail washing, separating, melting, and forming, among many other steps. Typically, when plastic packaging is reprocessed, the material is mechanically chopped into small pieces and then melted to be reformed into the new product. If multiple incompatible materials are present in the packaging, interactions occur during reprocessing causing gels, brittle material, poor appearance and generally un-usable or poor-quality products. Using the term “recyclable” indicates that these drawbacks are generally not present.

Qualification as a recyclable material is not regulated by any specific agencies but can be obtained from specific groups such as Association of Plastic Recyclers (APR), Circular Economy for Flexible Packaging (CEFLEX), and How2Recycle™.

Recyclable packaging films may be recycled with or without compatibilizer technology. Preferably, a recyclable film should not require additional compatibilizer.

Some recycling streams accept mixed polymers of a similar nature, such as polyolefins that contain, for example, polypropylene and polyethylene. Some recycling streams do not accept substantially mixed streams.

Preferably, a recyclable packaging film as described herein comprises 80% or more polyolefin by weight. More preferably, a recyclable packaging film as described herein comprises 90% or more polyolefin by weight, such as 95% or more polyolefin by weight. In some preferred embodiments, the recyclable packaging film comprises 80% or more polypropylene by weight. More preferably, a recyclable packaging film as described herein comprises 90% or more polypropylene by weight, such as 95% or more polypropylene by weight. Preferably, a recyclable packaging film as described herein comprises 20% or less EVOH by weight. More preferably, a recyclable packaging film as described herein comprises 10% or less EVOH by weight, such as 5% or less EVOH by weight.

“Polyolefin” is used herein broadly to include polymers such as polyethylene, ethylene-alpha olefin copolymers (EAO), polypropylene, polybutene, ethylene copolymers having a majority amount by weight of propylene or ethylene polymerized with a lesser amount of a comonomer such as vinyl acetate, and other polymeric resins falling in the “olefin” family classification. Polyolefins may be made by a variety of processes well known in the art including batch and continuous processes using single, staged or sequential reactors, slurry, solution and fluidized bed processes and one or more catalysts including for example, heterogeneous and homogeneous systems and Ziegler, Phillips, metallocene, single site and constrained geometry catalysts to produce polymers having different combinations of properties. Such polymers may be highly branched or substantially linear and the branching, dispersity and average molecular weight and may vary depending upon the parameters and processes chosen for their manufacture in accordance with the teachings of the polymer arts.

In some embodiments, a polyolefin comprises one or more of an ionomer, heterogeneous ethylene alpha olefin copolymer, a homogeneous ethylene alpha olefin copolymer, ethylene vinyl acetate copolymer, ethylene methyl acrylate copolymer, ethylene propylene copolymer, polypropylene homopolymer or copolymer, polybutylene homopolymer or copolymer, and blends thereof.

In some embodiments, a polyolefin comprises polypropylene. The term “polypropylene” is used herein (unless indicated otherwise) to refer to propylene homopolymers as well as copolymers of propylene with α-olefins and the term will be used without regard to the presence or absence of substituent branch groups. “PP” is used herein interchangeably with “polypropylene.”

Preferably, a “polypropylene layer” comprises 90% or more polypropylene by weight, such as 95% or more polypropylene by weight, 97% or more polypropylene by weight. 98% or more polypropylene by weight, or 99% or more polypropylene by weight.

In some embodiments, a polyolefin comprises polyethylene. The term “polyethylene” is used herein (unless indicated otherwise) to refer to ethylene homopolymers as well as copolymers of ethylene with α-olefins and the term will be used without regard to the presence or absence of substituent branch groups. “PE” is used herein interchangeably with “polyethylene.”

The polyethylene may be a “low density polyethylene” (LDPE). LDPE is used to denominate branched homopolymers having densities between 0.915 and 0.930 g/cm³. LDPEs typically contain long branches off the main chain (often termed “backbone”) with alkyl substituents of 2 to 8 carbon atoms.

The polyethylene may be an EAO. EAOs are copolymers having an ethylene as a major component copolymerized with one or more alpha olefins such as octene-1, hexene-1, or butene-1 as a minor component. EAOs include polymers known as linear low density polyethylene (“LLDPE”), very low density polyethylene (“VLDPE”), ultralow density polyethylene (“ULDPE”), and plastomers and may be made using a variety of processes and catalysts including metallocene, single-site and constrained geometry catalysts as well as Ziegler-Natta and Phillips catalysts.

Linear Low Density Polyethylene (LLDPE) are copolymers of ethylene with alpha-olefins having densities from 0.915 to 0.940 g/cm³. The α-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). The LLDPE may be produced with a metallocene or constrained geometry catalyst, which may be referred to as “mLLDPE”.

Very Low Density Polyethylene (VLDPE) and “Ultra Low Density Polyethylene” (ULDPE) are copolymers of ethylene with α-olefins, usually 1-butene, 1-hexene or 1-octene and are recognized by those skilled in the art as having a high degree of linearity of structure with short branching rather than the long side branches characteristic of LDPE. However, VLDPEs have lower densities than LLDPEs. The densities of VLDPEs are recognized by those skilled in the art to range between 0.860 and 0.915 g/cm³. Sometimes VLDPEs having a density less than 0.900 g/cm³ are referred to as “plastomers”.

Preferably, a “polyethylene layer” comprises 90% or more polyethylene by weight, such as 95% or more polyethylene by weight, 97% or more polyethylene by weight, 98% or more polyethylene by weight, or 99% or more polyethylene by weight.

The recycling packing films described herein may comprise a heat seal layer. The heat seal layer may comprise a polyolefin. In some embodiments, a polypropylene layer may be the heat seal layer. A polypropylene layer of the irradiated first film may be the heat seal layer. In some embodiments, a polypropylene heat seal layer is laminated to the irradiated first film. In some embodiments, a polyethylene layer may be the heat seal layer. Some examples of polyethylene that may be particularly well suited for use in a heat seal layer herein include LDPE, VLDPE, ULDPE, LLDPE, and ethylene vinyl acetate (EVA).

As used herein, a “seal layer” is a layer capable of fusion bonding by conventional indirect heating means which generate sufficient heat on at least one film contact surface for conduction to a contiguous film contact surface and formation of a bond interface therebetween without loss of the film integrity. The bond interface between contiguous inner layers preferably has sufficient physical strength to withstand the packaging process and subsequent handling.

As used herein, “EVOH” refers to ethylene vinyl alcohol copolymer. EVOH is otherwise known as saponified or hydrolyzed ethylene vinyl acetate copolymer and refers to a vinyl alcohol copolymer having an ethylene comonomer. EVOH is prepared by the hydrolysis (or saponification) of an ethylene-vinyl acetate copolymer. The degree of hydrolysis is preferably from about 50 to 100 mole percent, more preferably, from about 85 to 100 mole percent, and most preferably at least 97%. Greater degrees of hydrolysis (e.g., 97% or more) produce a more effective oxygen barrier.

EVOH is commercially available in resin form with various percentages of ethylene, and there is a direct relationship between ethylene content and melting point. For example, EVOH having a melting point of about 175° C. or lower is characteristic of EVOH materials having an ethylene content of about 38 mole percent (mol %) or higher. EVOH having an ethylene content of 38 mol % has a melting point of about 175° C. With increasing ethylene content, the melting point is lowered. Also, EVOH polymers having increasing mole percentages of ethylene have greater gas permeabilities. A melting point of about 158° C. corresponds to an ethylene content of 48 mol %. EVOH copolymers having lower or higher ethylene contents may also be employed. It is expected that processability and orientation would be facilitated at higher contents; however, gas permeabilities, particularly with respect to oxygen, may become undesirably high for certain packaging applications which are sensitive to microbial growth in the presence of oxygen. Conversely lower contents may have lower gas permeabilities, but processability and orientation may be more difficult.

Examples of commercially available EVOH include resins available from Eval Company of America under the tradename Eval™. Examples of commercially available EVOH films include Eval™ EF-E, Eval™ EF-F, and Eval™ EF-XL, available from Eval Company of America.

As used herein, an “EVOH layer” is a layer comprising 85% or more EVOH by weight, such as 90% or more EVOH by weight or 95% or more EVOH by weight.

Exposing EVOH layers to ionizing radiation may increase the oxygen barrier properties. Without intending to be bound by theory, it is believed that exposing the EVOH to ionizing radiation generates free radicals within the EVOH, and the free radicals act as an oxygen absorber.

Surprisingly, the inventors found that the ability of ionizing radiation to improve oxygen barrier properties (e.g., reduction of oxygen transmission rate) of multilayer films having an EVOH layer varied depending on the composition of other layers of the multilayer film. Some adjacent layers substantially prevented the ionizing radiation from enhancing the barrier properties of the EVOH layer, while other adjacent layers enhanced the ability of ionizing radiation to improve the barrier properties of the film. For example, the length of time that the multilayer film exhibited enhanced barrier properties following exposure to ionizing radiation was increased when the EVOH layer was between layers of certain compositions. Polypropylene was determined to be particularly effective at enhancing the improved oxygen barrier property effect of ionizing radiation on the EVOH layer.

Ionizing radiation is radiation that has sufficient energy to remove electrons from atoms, causing the atom to become charged or ionized. Ionizing radiation may consist of electromagnetic waves or subatomic particles. Sources of ionizing radiation include electron beam (e-beam) and gamma ray radiation sources. Electron beam radiation is preferred.

Dosages of radiation required to effect the desired reduction in oxygen permeability of the first film, or the recyclable packaging film comprising the irradiated first film, are preferably in the range of about 1 Mrads to about 20 Mrads, more preferably in the range of about 5 Mrads to about 15 Mrads. Increasing radiation levels may produce an increase in duration of the reduction in oxygen permeability. However, in some cases, increased radiation levels may reduce barrier efficacy. Irradiation is preferably carried out in an inert atmosphere, i.e., non-oxygen-containing atmosphere, such as, for example. a nitrogen or argon atmosphere.

Preferably, exposure of the first film to the ionizing radiation results in oxygen permeability of less than 0.3 cm³/m²/24 hours of the first film, or the recyclable packaging film comprising the first film, when measured according to ASTM D3985-17, Standard Test Method for Oxygen Gas Transmission Rate Through Plastic Film and Sheeting Using a Coulometric Sensor, ASTM International, West Conshohocken, PA, 2017; when measured 24 hours after irradiating the first film. More preferably, exposure of the first film to the ionizing radiation results in oxygen permeability of less than 0.2 cm³/m²/24 hours of the first film, or the recyclable packaging film, such as less than 0.1 cm³/m²/24 hours of the first film, or the recyclable packaging film, or zero (0) cm³/m²/24 hours of the first film, or the recyclable packaging film, when measured 24 hours after irradiating the first film. Preferably. the first film or recyclable packing film, has such oxygen transmission rates (less than 0.03 cm³/m²/24 hours, less than 0.2 cm³/m²/24 hours, less than 0.1 cm³/m²/24 hours, or 0 cm³/m²/24 hours) when measured 48 hours or more after irradiation of the first film, such as 96 hours or more after irradiation of the first film, 1 week or more after irradiation of the first film, or one month or more after irradiation of the first film. The irradiated first film or recyclable packaging film comprising the irradiated first film may be stored under dry conditions following irradiation until tested for oxygen permeability. The irradiated packaging film may be stored under reduced oxygen conditions following irradiation until tested for oxygen permeability. The irradiated films may be vacuum packed and stored until being subjected to oxygen permeability testing.

Exposure of the first film to ionizing radiation may result in an increase in free radicals in the first film. In some embodiments, the concentration of free radicals in the first film, or in a recyclable packaging film comprising the irradiated first film, is greater than 1×10¹⁷ spins per gram of EVOH after irradiating the first film, such as 1×10¹⁶ spins per gram of EVOH after irradiating the first film, 1×10¹⁵ spins per gram of EVOH after irradiating the first film, or 1×10¹⁴ spins per gram of EVOH after irradiating the first film. In some embodiments, the concentration of free radicals in the first film or in the recyclable packaging film in a range from 1×10¹⁴ spins per gram of EVOH to 1×10²⁵ spins per gram of EVOH. The concentration of free radicals may be measured via electron spin resonance spectroscopy. For example, the concentration of free radicals may be measured as described in L. Wall, “Electron Spin Resonance Studies of Free Radicals in Irradiated Materials,” in Materials in Nuclear Applications, (West Conshohocken, PA: ASTM International, 1960), 208-223. https:/doi.org/10.1520/STP39598S. The concentration of entrapped free-radicals may be measured on the irradiated films by electron spin resonance (ESR) using a Bruker EMX X-band spectrometer. Immediately after irradiation, the film specimens may be vacuum packed in foil pouches to limit exposure to oxygen. Samples may be stored at ambient conditions. ESR measurements may also be made at ambient conditions. ESR may be calibrated using 2,2-diphenyl-1-picrylhydrazyl (DPPH) stable free radical solution. Entrapped radicals in EVOH may be detected on the ESR between magnetic fields ranging from 3400 Gauss and 3600 Gauss.

The concentration of free radicals in irradiated EVOH may decrease over time. As the concentration of free radicals decreases, the oxygen barrier properties of irradiated EVOH may be reduced (e.g., the oxygen transmission rate may increase).

Exposure of an EVOH layer to high relative humidity, such as 65% or greater, 80% or greater, or 90% or greater, may reduce the oxygen barrier properties (e.g., increase the oxygen transmission rate) through the EVOH layer. Accordingly, the first and second polypropylene layers, between which the EVOH layer is disposed, of the first film described herein may serve to protect the EVOH layer from moisture ingress.

In some embodiments, the recyclable packing films described herein may be used to package products, such as food products. The products may be wet products, such as wet food products. At least in part because of the moisture resistant properties of the first and second polypropylene layers, the recyclable packaging films described herein may be used to package wet products despite the use of EVOH as an oxygen barrier layer.

The first irradiated film may have any suitable number of layers. The first irradiated film may comprise the first polypropylene layer, the second polypropylene layer, the EVOH layer between the first and second polypropylene layers, and any other suitable layers. The first irradiated film may comprise one or more tie layers.

The first irradiated film may consist essentially of the first polypropylene layer, the second polypropylene layer, the EVOH layer between the first and second polypropylene layers. The first irradiated film may consist essentially of the first polypropylene layer, the second polypropylene layer, the EVOH layer between the first and second polypropylene layers and one or more tie layers. The first irradiated film may consist essentially of the first polypropylene layer, the second polypropylene layer, the EVOH layer between the first and second polypropylene layers, a first tie layer between the first polypropylene layer and the EVOH layer, and a second tie layer between the second polypropylene layer and the EVOH layer.

As used herein, “consisting essentially of” (and any form of consisting essentially of, such as “consists essentially of” and “consist essentially of”) means the article, film, layer, composition, method, or the like includes the specified enumerated elements; such as layers, components, compounds, materials, steps, or the like, and may include additional elements that do not materially affect the basic and novel characteristics of the article, film, layer, composition, method, or the like.

The first irradiated film may consist of the first polypropylene layer, the second polypropylene layer, the EVOH layer between the first and second polypropylene layers. The first irradiated film may consist of the first polypropylene layer, the second polypropylene layer, the EVOH layer between the first and second polypropylene layers and one or more tie layers. The first irradiated film may consist of the first polypropylene layer, the second polypropylene layer, the EVOH layer between the first and second polypropylene layers, a first tie layer between the first polypropylene layer and the EVOH layer, and a second tie layer between the second polypropylene layer and the EVOH layer.

“Tie layers” are adhesive layers that may be selected to promote the adherence of adjacent layers to one another in a multilayer film and prevent undesirable delamination. A multifunctional layer is preferably formulated to aid in the adherence of one layer to another layer without the need of using separate adhesives by virtue of the compatibility of the materials in that layer to the first and second layers. In some embodiments, adhesive layers comprise materials found in both the first and second layers.

Multilayer films may comprise any suitable number of tie or adhesive layers of any suitable composition. Various adhesive layers are formulated and positioned to provide a desired level of adhesive between specific layers of the film according to the composition of the layers contacted by the tie layers.

The recyclable packaging film may comprise a second film laminated to the irradiated first layer. To maintain recyclability, it is preferred that the second film comprises or consists essentially of a polyolefin. The second film may be a polyolefin film. The second film may be a polypropylene film or may be a polyethylene film.

The recyclable packaging film may comprise a third film laminated to first film on a side opposing the second film. Preferably the third film comprises or consists essentially of a polyolefin. The third film may be a polyolefin film. The third film may be a polypropylene film or may be a polyethylene film.

In some embodiments, the second film is a film suitable for receiving printing material, such as ink. That is, the second film may be printed. Preferably, the second film is reverse printed such that the printing material is disposed on the side of the second film that contacts the first film when the second film is laminated to the first film.

The second film may be any suitable film for receiving printing material. Preferably. the second film is an oriented polypropylene film, such as a biaxially oriented polypropylene (BOPP) film.

The second film may be an outer layer of the recyclable packaging film. That is, when the recyclable packaging film is used to seal a product to form a packaged product, a surface of the second film may be an exterior surface of the packaged product.

Since the outer layer of the recyclable packaging film may be seen by a user, the exterior surface of the outer layer of the recyclable packaging film preferably has desirable optical properties such as matte or gloss effects. Also, the exterior surface of the outer layer preferably withstands contact with sharp objects and provides abrasion resistance.

The exterior surface layer should be easy to machine (i.e., be easy to feed through and be manipulated by machines, e.g., for conveying, packaging, printing or as part of the film or packaging manufacturing process). Suitable stiffness, flexibility, flex crack resistance, modulus, tensile strength, coefficient of friction, printability, and optical properties are also frequently designed into exterior layers by suitable choice of materials. This layer may also be chosen to have characteristics suitable for creating desired heat seals which may be resistance to burn through, e.g., by impulse sealers or may be used as a heat-sealing surface in certain package embodiments, e.g., using overlap seals. The second film may be oriented, e.g., uni-axially or bi-axially oriented.

The third film may comprise or consist essentially of a seal layer. Preferably, the third film is a seal layer. The third film or the seal layer may comprise or consist essentially of a polyolefin. The third film or the seal layer may be a polyolefin film or layer. The third film or seal layer may be a polypropylene film or layer or may be a polyethylene film or layer.

In some embodiments, the first film may be oriented. Preferably, the first film is biaxially oriented. If oriented, the first film may be suitable for receiving printing material. The first film may be oriented before or after the first film is irradiated.

If the first film is oriented, the second film preferably comprises or consists essentially of a seal layer. Preferably, the second film is a seal layer. The seal layer may comprise or consist essentially of a polyolefin. The seal layer may be a polyolefin layer. The seal layer may be a polypropylene layer or may be a polyethylene layer.

The first film may be an outer layer of the recyclable packaging film. If the first film is an outer layer of the recyclable packaging film, the first film is preferably oriented, such as uni-axially or bi-axially oriented.

Various additives may be included in the polymers utilized in one or more layers of the film. Conventional antiblock additives, polymeric plasticizers, acid, moisture or gas (such as oxygen) scavengers, slip agents, colorants, dyes, pigments, organoleptic agents may be added to one or more film layers of the film or the film or one or more layers may be free from such added ingredients. Preferably, the EVOH layer is free from additives, such as anti-oxidants or gas scavengers, that may reduce the concentration of free radicals and counteract the effects of ionizing radiation. The first film may be free from additives that may reduce the concentration of free radicals.

A recyclable packaging film described herein may have any suitable thickness. In some embodiments, the film has a total thickness of less than about 50 mil (1270 micrometers), more preferably the film has a total thickness of from about 1.0 mil (25.4 micrometers) to about 10 mil (254 micrometers), such as from about 1 mil (25.4 micrometers) to about 5 mil (127 micrometers), or from about 2 mil (50.8 micrometers) to about 3.5 mil (88.9 micrometers). For example, entire recyclable packaging film or any single layer of a recyclable packaging film may have any suitable thicknesses, including 1, 2, 3, 4, 5, 6, 7, 8, 9, 10, or 50 mil, or any increment of 0.1 or 0.01 mil therebetween.

In some embodiments, the recyclable packaging films are as thick as 50 mil (1270 micrometers) or higher, or as thin as 1 mil (25.4 micrometers) or less. In various embodiments, the recyclable packaging film have a thickness of between about 2 mil (50.8 micrometers) to about 4 mil (101.6 microns).

The recyclable packaging film is preferably dimensionally stable. In some embodiments, the recyclable packaging film has a has a shrink value less than 20% in both the machine direction and the transverse direction when tested according to ASTM D2732-14 (2020), Standard Test Method for Unrestrained Linear Thermal Shrinkage of Plastic Film and Sheeting, ASTM International, West Conshohocken, PA, 2020, using a bath temperature of 90 degrees Celsius. Preferably, the recyclable packaging film has a shrink value less than 10% in both the machine direction and the transverse direction, such as less than 7%, less than 5%, less than 3%, or less than 2%.

The films described herein may be made in any suitable manner, such as by conventional processes. Processes to produce flexible films may include, e.g., cast or blown film processes, or extruding processes. Preferably, the first film comprising the EVOH layer between the first and second polypropylene layers is formed by co-extrusion or casting.

The second film and third film, if present, may be laminated to the first film. Where lamination is carried out after irradiation of the first film, adhesives are preferably used. Lamination methods requiring the use of elevated temperatures are generally not preferred when lamination is carried out after irradiation as exposure to high temperature may reduce the improved oxygen barrier properties achieved through irradiation.

Packages may be formed from the recyclable packaging films in any suitable manner. For example, the packages may be formed by heat sealing a heat seal layer of the film to a substrate. The substrate may comprise, for example, the film itself, another suitable film, or another suitable structure. In some embodiments, the recyclable packaging film is heat sealed across an opening of a container.

A packaged product may comprise a product, a recyclable packaging film as described herein, and optionally a packaging structure. The recyclable packaging film may be heat sealed to itself or the package structure to define an interior space. The product may be disposed in the interior space.

With the above general discussion in mind, reference in now made to the embodiments shown in the figures.

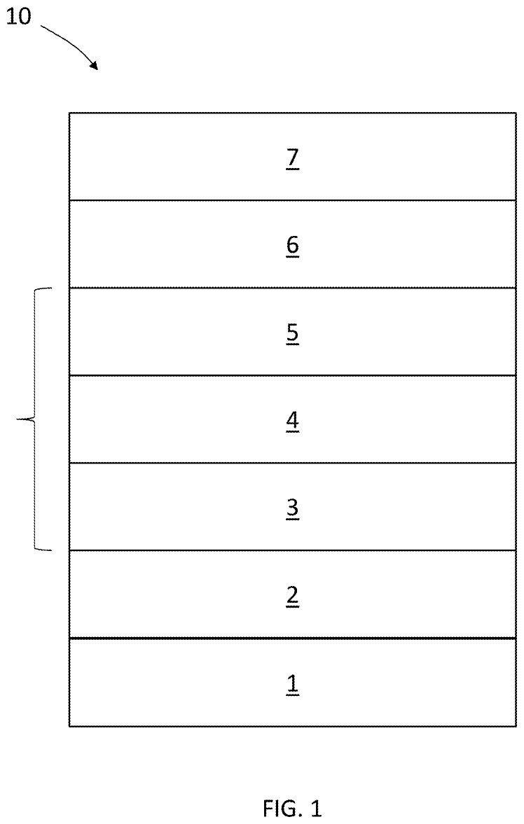

Referring to FIG. 1, a schematic drawing of a cross-section of a recyclable packaging film 10 in accordance with an embodiment described herein. In the depicted embodiment, the recyclable packaging film 10 includes seven layers. On one surface is an outer layer 7, which corresponds to a second film. The outer layer/second film 7 is preferably an oriented polypropylene film. Tie layer 6 is used to laminate the second film 7 to the first film 9, which includes first polypropylene layer 5, EVOH layer 4, and second polypropylene layer 3. Tie layers (not shown) may be between EVOH layer 4 and the first polypropylene layer 5 and between EVOH layer 4 and the second polypropylene layer 3. On the other surface is a seal layer 1, which corresponds to a third film. The seal layer/third film 1 preferably is a polyolefin film. The third film/seal layer 1 is laminated to the first film 9, via tie layer 2.

The first film 9 may be irradiated with ionizing radiation, such as e-beam radiation, prior to laminating the first 7 and second 1 films to the first film 9.

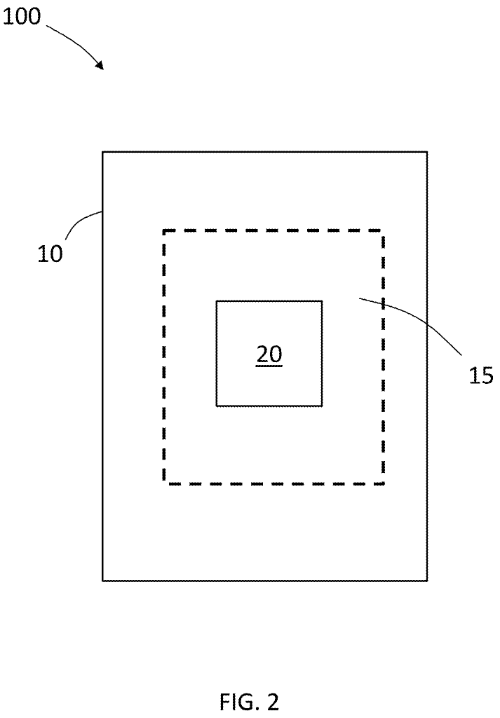

Referring now to FIG. 2, a schematic view of an embodiment of a packaged product 100 is shown. In the depicted embodiment, the packaged product 100 includes a product 20 sealed in a film 10 as described herein. The dashed lines in FIG. 2 represent the boundaries of an interior volume 15 formed by the film 10 (in this case, wrapped around the product 20 and sealed around the perimeter). The product 20 may be a food product, such as a wet food product.

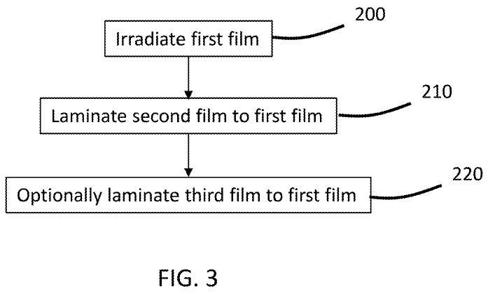

Referring now to FIG. 3, a flow diagram illustrating an embodiment of a method for manufacturing a recyclable packaging film is shown. The method includes irradiating the first film (200). The first film is sufficiently irradiated with ionizing radiation, such as e-beam radiation, to improve oxygen barrier properties of the first film. For example, the ionizing radiation may increase concentration of free radicals in the EVOH layer, which may serve as an oxygen scavenger, and reduce oxygen transmission rate through the film. The method further includes laminating a second film to the first film (210) and, optionally, laminating a third film to the first film (220).

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all of the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open-ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower.” “above,” below,” and other directions and orientations are described herein for clarity in reference to the figures and are not to be limiting of an actual device or system or use of the device or system. Many of the devices, articles or systems described herein may be used in a number of directions and orientations.

As used herein, “providing” an article, such as a film, means to make, purchase, or otherwise obtain the article.

The term “layer” refers to a discrete component of a film that has a substantially uniform composition. A layer may or may not be coextensive with the film.

As used herein, a “polymer” refers to a material that is the product of polymerization or copolymerization of natural, synthetic or combined natural and synthetic monomers or co-monomers, or monomers and co-monomers, and is inclusive of homopolymers, copolymers, terpolymers, and the like. A layer may comprise a single polymer, a mixture of a polymer and non-polymeric material, a combination of two or more polymers blended together, or a mixture of two or more polymers and non-polymeric material.

A “polyolefin,” “polyethylene,” “polypropylene,” or “EVOH” are inclusive of not only polymers comprising repeating units derived from monomers known to polymerize to form a polymer of the named type, but are also inclusive of comonomers, as well as both unmodified and modified polymers made by e.g. derivatization of a polymer after its polymerization to add functional groups or moieties along the polymeric chain. Furthermore, terms identifying polymers are also inclusive of “blends” of such polymers.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a film comprising a polyolefin and EVOH include embodiments where the film consists of a polyolefin and EVOH and embodiments the film consists essentially of a polyolefin and EVOH.

A number of examples of recyclable packaging film and methods have been described herein. A non-exhaustive list of non-limiting examples are listed below. Any one or more of the features of these examples may be combined with any one or more features of another example or aspect described herein.

Example Ex: A recyclable packaging film, comprising: an irradiated first film; and a second film laminated to the first film, the first film comprising a first polypropylene (PP) layer, a second PP layer, and an ethylene vinyl alcohol (EVOH) layer between the first and second PP layers.

Example Ex2: The recyclable packaging film of Example Ex1, wherein the second film comprises an oriented PP layer.

Example Ex3: The recyclable packaging film of Example Ex2, comprising printing material printed on the oriented PP layer.

Example Ex4: The recyclable packaging film of Example Ex2 or Example Ex3, wherein the first film is not oriented.

Example Ex5: The recyclable packaging film of any one of Examples Ex2 to Ex4, further comprising a third film laminated to the first film.

Example Ex6: The recyclable packaging film of Example Ex5, wherein the third film comprises a seal layer.

Example Ex7: The recyclable packaging film of Example Ex6, wherein the seal layer comprises a polyolefin.

Example Ex8: The recyclable packaging film of Example Ex6, wherein the seal layer comprises PP.

Example Ex9: The recyclable packaging film of Example Ex1, wherein the second film comprises a seal layer.

Example Ex10: The recyclable packaging film of Example Ex9, wherein the seal layer comprises a polyolefin.

Example Ex11: The recyclable packaging film of Example Ex9, wherein the seal layer comprises PP.

Example Ex 12: The recyclable packaging film of any one of Examples Ex9 to Ex11, wherein the first film is oriented.

Example Ex 13: The recyclable packaging film of Example Ex12, wherein the first film is biaxially oriented.

Example Ex14: The recyclable packaging film of Examples Ex1 to Ex13, wherein the packaging film has a shrink value less than 10% in both the machine direction and the transverse direction when tested according to ASTM D2732 using a bath temperature of 90 degrees Celsius.

Example Ex15: The recyclable packaging film of Example Ex14, wherein the packaging film has a shrink value less than 7% in both the machine direction and the transverse direction.

Example Ex16: The recyclable packaging film of Example Ex14, wherein the packaging film has a shrink value less than 5% in both the machine direction and the transverse direction.

Example Ex17: The recyclable packaging film of Example Ex14, wherein the packaging film has a shrink value less than 3% in both the machine direction and the transverse direction.

Example Ex18: The recyclable packaging film of Example Ex14, wherein the packaging film has a shrink value less than 2% in both the machine direction and the transverse direction.

Example Ex 19: The recyclable packaging film according to any one of Examples Ex1 to Ex18, wherein the packaging film comprises 10% or less EVOH by weight.

Example Ex20: The recyclable packaging film according to any one of Examples Ex1 to Ex19, wherein the packaging film comprises 5% or less EVOH by weight.

Example Ex21: The recyclable packaging film according to any one of Examples Ex1 to Ex20, wherein the packaging film comprises 90% or more polyolefin by weight.

Example Ex22: The recyclable packaging film according to any one of Examples Ex1 to Ex21, wherein the packaging film comprises 95% or more polyolefin by weight.

Example Ex23: The recyclable packaging film according to any one of Examples Ex1 to Ex22, wherein the packaging film comprises 90% or more PP by weight.

Example Ex24: The recyclable packaging film according to any one of Examples Ex1 to Ex23, wherein the packaging film comprises 95% or more PP by weight.

Example Ex25: The recyclable packaging film according to any one of Examples Ex1 to Ex24, wherein the packaging film has an oxygen permeability of less than 0.3 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 within 24 hours after irradiating the first film.

Example Ex26: The recyclable packaging film according to Example Ex25, wherein the packaging film has an oxygen permeability of less than 0.1 cm³/m²/24 hours.

Example Ex27: The recyclable packaging film according to Example Ex25, wherein the packaging film has an oxygen permeability of zero (0) cm³/m²/24 hours.

Example Ex28: The recyclable packaging film according to any one of Examples Ex1 to Ex27, wherein the packaging film has an oxygen permeability of less than 0.3 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 one week after the first film is irradiated.

Example Ex29: The recyclable packaging film according to Example Ex28, wherein the packaging film has an oxygen permeability of less than 0.1 cm³/m²/24 hours.

Example Ex30: The recyclable packaging film according to Example Ex28, wherein the packaging film has an oxygen permeability of zero (0) cm³/m²/24 hours.

Example Ex31: The recyclable packaging film according to any one of Examples Ex1 to Ex30, wherein the packaging film has an oxygen permeability of less than 0.3 cm³/m²/24 hours when measured according to ASTM D3985-17, Standard Test Method for Oxygen Gas Transmission Rate Through Plastic Film and Sheeting Using a Coulometric Sensor, ASTM International, West Conshohocken, PA, 2017 one month after the first film is irradiated.

Example Ex32: The recyclable packaging film according to Example Ex31, wherein the packaging film has an oxygen permeability of less than 0.1 cm³/m²/24 hours.

Example Ex33: The recyclable packaging film according to Example Ex31, wherein the packaging film has an oxygen permeability of zero (0) cm³/m²/24 hours.

Example Ex34: The recyclable packaging film of any one of Examples Ex1 to Ex33 for use in packaging a food product.

Example Ex35: A method comprising: providing the recyclable packaging film according to any one of Examples Ex1 to Ex 33; providing a food product; and sealing the food product in the packaging film to form a packaged food product.

Example Ex36: A package food product, comprising: the recyclable packaging film of any one of the Examples Ex1 to Ex33; and a food product packaged in the recyclable packaging film.

Example Ex37: The packaged food product of Example Ex36, wherein the food product is sealed in the recyclable packaging film.

Example Ex38: A method for manufacturing a recyclable packaging film, comprising: forming a first film comprising a first polypropylene (PP) layer, a second PP layer, and an ethylene vinyl alcohol (EVOH) layer between the first and second PP layers; exposing the first film to ionizing radiation to form an irradiated first film; and laminating the first film to a second film.

Example Ex39: The method of Example Ex38, wherein forming the first film comprises coextruding the first PP layer, the second PP layer, and the EVOH layer.

Example E40: The method of Example Ex38 or Ex39, wherein the second film comprises an oriented PP layer.

Example Ex41: The method of Example Ex40, comprising printing material on the oriented PP layer.

Example Ex42: The method of Example Ex41, wherein the material is printed on the oriented PP layer before the first film is laminated to the second film.

Example Ex43: The method of any one of Examples Ex38-42, further comprising laminating a third film to the first film.

Example Ex44: The method of Example Ex43, wherein the third film comprises a seal layer.

Example Ex45: The method of Example Ex44, wherein the seal layer comprises a polyolefin.

Example Ex46: The method of Example Ex45, wherein the seal layer comprises PP.

Example Ex47: The method of Example Ex38, wherein the second film comprises a seal layer.

Example Ex48: The method of Example Ex47, wherein the seal layer comprises a polyolefin.

Example Ex49: The method of Example Ex47, wherein the seal layer comprises PP.

Example Ex50: The method of any one of Examples Ex47-49, comprising orienting the first film.

Example Ex51: The method of Example Ex50, wherein orienting the first film comprises biaxially orienting the first film.

Example Ex52: The method of Example Ex50 or Ex51, comprising printing material on the first film.

Example Ex53: The method of Example Ex52, wherein the material is printed on the first film before the first film is laminated to the second film.

Example Ex54: The method of any one of Examples Ex38-53, wherein exposing the first film to ionizing radiation comprises exposing the first film to a dose of radiation sufficient to increase a barrier property of the first film.

Example Ex55: The method of Example Ex54, wherein the barrier property is an oxygen transmission property.

Example Ex56: The method of Example Ex54, wherein the barrier property is water vapor transmission property.

Example Ex57: The method of any one of Examples Ex38-56, wherein exposing the first film to ionizing radiation comprises exposing the first film electron beam radiation.

Example Ex58: The method of any one of Examples Ex38-57, wherein the packaging film comprises 10% or less EVOH by weight.

Example Ex59: The method of any one of Examples Ex38-57, wherein the packaging film comprises 5% or less EVOH by weight.

Example Ex60: The method of any one of Examples Ex38-57, wherein the packaging film comprises 90% or more polyolefin by weight.

Example Ex61: The method of any one of Examples Ex38-57, wherein the packaging film comprises 95% or more polyolefin by weight.

Example Ex62: The method of any one of Examples Ex38-57, wherein the packaging film comprises 90% or more PP by weight.

Example Ex63: The method of anyone of Examples Ex38-57, wherein the packaging film comprises 95% or more PP by weight.

Following are examples given to illustrate the invention, but these examples should not be taken as limiting the scope. All percentages are by weight unless indicated otherwise.

### EXAMPLES

In the following examples, all the polymer film samples were exposed to a 200 KV electron beam at room temperature.

Oxygen permeability of each film was measured at 25° C. and 50% relative humidity unless otherwise indicated using a Mocon Dual Channel Permeability Tester (Pax-Tran II) manufactured by Modem Controls, Inc., Minneapolis, Minn., according to ASTM D3985-17, Standard Test Method for Oxygen Gas Transmission Rate Through Plastic Film and Sheeting Using a Coulometric Sensor, ASTM International. West Conshohocken, PA, 2017.

In some examples, the irradiated films were then stored at ambient conditions and further oxygen permeability measurements performed periodically on the same film sample within each example as a function of storage time.

### Example 1: EVOH Monolayer

A monolayer EVOH (38 mole % ethylene content) film was made on a cast line as follows. A polyethylene/EVOH/polyethylene structure was coextruded, followed by peeling off of the polyethylene skin layers. The resulting film was IR scanned to ensure the polyethylene layers were completely peeled off and measured for thickness. The EVOH monolayer film was subjected to 9 Mrad or 18 Mrad of radiation and was tested for oxygen transmission rate properties at different relative humidity (RH) conditions.

The RH conditions were 0/0, 50/50, and 50/90, where the first number indicates the relative humidity exposed to the non-food side of the film and the second number indicates the relative humidity exposed to the food side of the film. The results are shown in Table 1 below.

TABLE 1
Oxygen transmission rate (OTR)
of EVOH monolayer at various RH

| Radiation | OTR cm³/m²/24 hours | | | Thickness |
|---|---|---|---|---|
| level | 0/0 | 50/50 | 50/90 | (mil) |
| Untreated | 0.91 | 0.62 | 1.8 | 0.85 |

| | | | | | |
|---|---|---|---|---|---|
| 9 | Mrad | 0.01 | 0 | 1.3 | 0.88 |
| 18 | Mrad | 0.092 | 0.06 | 2.1 | 0.90 |

The results presented in Table 1 show that irradiation may produce substantial improvement in OTR of monolayer EVOH films.

As illustrated by Table 1, increased relative humidity may adversely affect OTR of EVOH monolayer films and may reduce the benefits of ionizing irradiation.

### Example 2: Mulitlayer Films Having EVOH Layers

Because EVOH monolayers are rarely used as films, multilayer films containing an EVOH layer were tested to see whether other film layers would protect EVOH from high relative humidity conditions or to allow improved oxygen barrier properties following ionizing irradiation. The following films were tested Example 2A: PE/Ionomer/EVA TIE/EVOH/EVA TIE/Ionomer/EVA Seal layer and Example 2B Nylon/Tie/PE/Tie/Nylon/EVOH/Nylon/Tie/PE/PE/PE. The results are presented in Table 2 below.

TABLE 2
OTR of Multilayer films at high RH

| | Radiation | OTR | |
|---|---|---|---|
| Film | dose | (cm³/m²/day) | RH |
| Example 2A | 0 | 9.72 | 50/90 |
| | 9 | 9.83 | 50/90 |
| Example 2B | 0 | 11.66 | 50/90 |
| | 9 | 10.98 | 50/90 |

### Example 3: Effect of Adjacent Polymer Layers on OTR Performance of Irradiated EVOH

Three layer films were coextruded on a cast line with EVOH (38 mole % ethylene content) being the core layer. The films were subjected to radiation and OTR was determined approximately 6 to 8 weeks following irradiation. The results are presented in Table 3 below.

TABLE 3
Effect of adjacent polymer layers

| | Dosage | OTR | |
|---|---|---|---|
| Film Structure | (Mrad) | (cm³/m²/day) | RH |
| EVA/EVOH/EVA | 0 | 0.92 | 50/50 |
| | 9 | 1.07 | 50/50 |
| PE/EVOH/PE | 0 | 0.52 | 50/50 |
| | 9 | 0.66 | 50/50 |
| PA 6/EVOH/PA 6 | 0 | 1.13 | 50/50 |
| | 9 | 1.62 | 50/50 |
| PA 66/EVOH/PA 66 | 0 | 0.5 | 50/50 |
| | 9 | 0.93 | 50/50 |
| PA 666/EVOH/PA 666 | 0 | 1.03 | 50/50 |
| | 9 | 1.09 | 50/50 |
| PP/EVOH/PP | 0 | 0.45 | 50/50 |
| | 9 | 0.02 | 50/50 |

### Example 4: Effect of Ethylene mol % Content of EVOH on OTR Performance

Coextruded cast films were prepared with the following ethylene mol % content of EVOH: 29 mol %, 38 mol % and 44 mol %. The films were irradiated and were tested for OTR at different RH conditions approximately 6 to 8 weeks (unless indicated otherwise) following irradiation. For each of the films, the PP tie layer was formed from Admer PP tie 520A. The results are presented below in Table 4.

TABLE 4
Effect of ethylene mol % of EVOH

| | Dosage | OTR | |
|---|---|---|---|
| Film Structure | (Mrad) | (cm³/m²/day) | RH |
| PP/EVOH/PP | 0 | 0.06 | 50/50 |
| (EVOH: 29 mol % ethylene) | 9 | 0 | |
| | 0 | 0.72 | 80/80 |
| | 9 | 0 (after 250+ h) | |
| PP/EVOH/PP | 0 | 0.42 | 50/50 |
| (EVOH: 38 mol % ethylene) | 9 | 0 | |
| | 0 | 1.61 | 80/80 |
| | 9 | 0 (for 59 h), | |
| | | 1.48 (after 4 days) | |
| PP/EVOH/PP | 0 | 5.39 | 50/50 |
| (EVOH: 44 mol % ethylene) | 9 | 8.48 | |
| | 0 | Not tested | 80/80 |
| | 9 | Not tested | |

### Conclusions

Based on the examples presented above the following conclusions are drawn: (1) e-beam radiation may enhance the oxygen barrier properties of EVOH films; (2) polymer layers next to the EVOH layer play a role in barrier enhancement, with polypropylene being a suitable polymer; and (3) ethylene mol % content of the EVOH layer may influence the OTR performance of e-beam treated films.

Thus, films, layers, packages, packaged products, and methods for RECYCLABLE PACKAGING FILM are described. Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in film manufacturing or related fields are intended to be within the scope of the following claims.

It will be apparent to those skilled in the art that various modifications and variations can be made to the present inventive technology without departing from the spirit and scope of the disclosure. Since modifications, combinations, sub-combinations, and variations of the disclosed embodiments incorporating the spirit and substance of the inventive technology may occur to persons skilled in the art, the inventive technology should be construed to include everything within the scope of the appended claims and their equivalents.

1. A recyclable packaging film, comprising:
an irradiated first film; and
a second film laminated to the first film,
the first film comprising a first polypropylene (PP) layer, a second PP layer, and an ethylene vinyl alcohol (EVOH) layer between the first and second PP layers, and the second film comprising an oriented PP layer.

2. (canceled)

3. The recyclable packaging film of claim 1, further comprising a third film laminated to the first film.

4. The recyclable packaging film of claim 3, wherein the third film comprises a seal layer.

5. The recyclable packaging film of claim 4, wherein the seal layer comprises a polyolefin.

6. The recyclable packaging film of claim 1, wherein the second film comprises a seal layer.

7. The recyclable packaging film of claim 6, wherein the seal layer comprises a polyolefin.

8. (canceled)

9. The recyclable packaging film according to claim 1, wherein the packaging film comprises 10% or less EVOH by weight.

10. The recyclable packaging film according to claim 1, wherein the packaging film comprises 90% or more polyolefin by weight.

11. The recyclable packaging film according to claim 1, wherein the packaging film comprises 90% or more PP by weight.

12. The recyclable packaging film according to claim 1, wherein the recyclable packaging film has a concentration of free radicals in a range from 1×10¹⁴ spins per gram of EVOH to 1×10²⁵ spins per gram of EVOH.

13. A method comprising:
providing the recyclable packaging film according to claim 1;
providing a food product; and
sealing the food product in the packaging film to form a packaged food product.

14. The method of claim 13, wherein the packaging film comprises 5% or less EVOH by weight.

15. A packaged food product, comprising:
the recyclable packaging film of claim 1; and
a food product packaged in the recyclable packaging film.

16. The packaged food product of claim 15, wherein the packaging film comprises 5% or less EVOH by weight.

17. A method for manufacturing a recyclable packaging film, comprising:
forming a first film comprising a first polypropylene (PP) layer, a second PP layer, and an ethylene vinyl alcohol (EVOH) layer between the first and second PP layers;
exposing the first film to ionizing radiation to form an irradiated first film; and
laminating the first film to a second film.

18. The method of claim 17, wherein forming the first film comprises coextruding the first PP layer, the second PP layer, and the EVOH layer.

19. The method of claim 17, wherein the second film comprises an oriented PP layer.

20. The method of claim 17, wherein exposing the first film to ionizing radiation comprises exposing the first film to a dose of radiation sufficient to reduce oxygen transmission rate of the first film.
